(19) United States
(12) Patent Application Publication
(10) Pub. No.: US 2012/0095749 A1
(43) Pub. Date: Apr. 19, 2012

(54) MULTI-FUNCTIONAL AUDIO DISTRIBUTION SYSTEM AND METHOD FOR MOVIE THEATERS AND OTHER PUBLIC AND PRIVATE VENUES

(76) Inventor: Antonio Capretta, Novato, CA (US)

(21) Appl. No.: 13/272,694

(22) Filed: Oct. 13, 2011

Related U.S. Application Data
(60) Provisional application No. 61/393,148, filed on Oct. 14, 2010.

(51) Int. Cl. G06F 17/20; G10L 19/00; H04B 3/00

(52) U.S. Cl. 704/8; 381/80; 381/81; 704/201; 704/200.1; 704/501; 704/E19.001

(57) ABSTRACT

Audiovisual presentation methods, systems and apparatus for improving and enhancing the listening experience of attendees of audiovisual presentations. An exemplary audiovisual presentation system includes an audio processing and distribution unit (APDU) configured to generate and broadcast a wireless audio service containing audio of an audiovisual presentation (e.g., soundtrack and dialogue audio of a movie, in the case of a movie presentation) throughout an audiovisual presentation room or space (e.g., a movie theater, in the case of a movie presentation). The wireless audio service is received by mobile receiving devices (MRDs) having or comprising headsets, headphones or earbuds, through which MRD users listen to the audio of the audiovisual presentation provided by the wireless audio service while viewing images of the audiovisual presentation.

### CROSS-REFERENCE TO RELATED APPLICATIONS

This patent application claims the benefit of U.S. Provisional Patent Application No. 61/393,148, which was filed on Oct. 14, 2010 and is hereby incorporated by reference in its entirety.

### FIELD OF THE INVENTION

The subject matter of this patent application relates generally to audiovisual presentation systems, and particularly to methods, systems and apparatus for improving and enhancing the listening experience of audiovisual presentation attendees.

### BACKGROUND OF THE INVENTION

People often attend audiovisual presentations for business and entertainment. Audiovisual presentations may be private or public, and are presented in an audiovisual room such as a movie theater, auditorium, or conference room, or in a large open space, such as a stadium, arena, pavilion, convention hall, outdoor space or open field.

In addition to displaying images of an image or video source (e.g., 35 mm film, in the case of a movie presentation in a theater), an audiovisual presentation involves amplifying and playing audio of the audiovisual presentation through speakers positioned at particular locations in the audiovisual presentation room or space. Unfortunately, there are a number of factors that can prevent or hinder an audiovisual presentation attendee's ability to hear the sound produced by the audiovisual presentation room or space speakers. For example, the attendee may have a hearing impairment, may be hidden behind an obstruction that is blocking the sound, or may simply be too far away from the speakers. Various other factors can prevent or interfere with the ability of an attendee to listen to the audio of the audiovisual presentation. For example, in an audiovisual presentation involving the presentation of a movie, an attendee may have difficulty listening to the movie audio due to impolite and talking attendees. Or, in a forum in which attendees are not expected to be quiet and there is a large number of attendees, such as a stadium, arena, pavilion or convention hall, talking attendees and other cacophony can interfere with an attendee's ability to listen to and enjoy the audio of the audiovisual presentation.

In addition to the foregoing problems, the sound produced by audiovisual presentation systems speaker systems is often of poor quality. Poor quality sound not only hinders the audiovisual presentation attendees' ability to hear and comprehend the audio of the audiovisual presentation, it also diminishes the attendees' listening experience and enjoyment of the audiovisual presentation.

It would be desirable, therefore, to have methods, systems and apparatus that avoid these and other audio-related problems associated with conventional audiovisual presentation systems.

### SUMMARY OF THE INVENTION

Audiovisual presentation methods, systems and apparatus for improving and enhancing the listening experience of attendees of audiovisual presentations are disclosed. An exemplary audiovisual presentation system includes an audio processing and distribution unit (APDU) configured to generate and broadcast a wireless audio service containing audio of an audiovisual presentation (e.g., soundtrack and dialogue audio of a movie, in the case of a movie presentation) throughout an audiovisual presentation room or space (e.g., a movie theater, in the case of a movie presentation). The wireless audio service is received by mobile receiving devices (MRDs) having or comprising headsets, headphones or earbuds through which MRD users listen to the audio of the audiovisual presentation provided by the wireless audio service while viewing images of the audiovisual presentation.

With the ability to listen to the audio of the audiovisual presentation through headsets, headphones or earbuds, MRD users are able to enjoy the audiovisual presentation while avoiding the nuisance and distraction of impolite and talking attendees and other cacophony that may be present in the audiovisual presentation room or space.

In one implementation of the invention, the audio processor of the APDU is configured to encrypt the audio of the audiovisual presentation so that only MRDs authorized and equipped to decrypt the encrypted audio may access the wireless audio service. In another implementation, the audio processor of the APDU is also configured to encode the audio of the audiovisual presentation according to a psychoacoustic encoding algorithm or other sound-enhancing process that produces enhanced sound (e.g., surround sound or other multi-dimensional or multi-channel sound effects) for the MRD users' headsets, headphones or earbuds. The ability of an MRD user to listen to the audio of the audiovisual presentation in enhanced sound through their MRD headsets, headphones or earbuds not only improves the ability to hear and comprehend the audio of the audiovisual presentation, it also intensifies and accentuates the attendees' listening experience and enjoyment beyond that which could be experienced by listening to the audio from sound produced by the audiovisual system's speaker system.

In one implementation of the invention, the MRDs comprise cell phones, smart phones, personal digital assistants (PDAs), digital audio players, or other mobile devices of MRD users. The mobile devices/MRDs are equipped with a software application (i.e., “app”) which is downloaded to the mobile device/MRD from an Internet-based app server (or “app store”) and includes instructions, which, when executed by a mobile device's/MRD's processor, causes the processor to perform various operations, including presenting a graphical user interface (GUI) on a display of the mobile device/MRD. The GUI provides the MRDs and MRD users the ability to, among other things: access the wireless audio service provided by the APDU; control audio characteristics (e.g., volume, tone, enhanced sound, mute, etc.) of the audio provided by the wireless audio service; request a language preference of the audio provided by the wireless audio service; request information and details of the audiovisual presentation; link to audiovisual-presentation-related website vendors; and/or link to marketing and/or promotional websites.

Further features and advantages of the present invention, including descriptions of the structure and operation of the above-summarized and other exemplary embodiments of the invention, will now be described in detail with respect to accompanying drawings, in which like reference numbers are used to indicate identical or functionally similar elements.

### BRIEF DESCRIPTION OF THE DRAWINGS

FIG. 1 is a drawing of an audiovisual presentation system employing an audio processing and distribution unit (APDU), according to an embodiment of the present invention;

FIG. 2 is a drawing illustrating how the image and audio source of the APDU of the audiovisual presentation system in FIG. 1 comprises 35 mm film, and how the APDU connects to an audio subsystem of the audiovisual presentation system;

FIG. 3 is a drawing of a movie theater multiplex (or megaplex) having a plurality of theaters equipped with a plurality of APDUs, each APDU similar to the APDU shown and described in reference to FIG. 2, according to an embodiment of the present invention;

FIG. 4 is a drawing showing details of the APDU and a mobile receiving device (MRD) configured to receive the wireless audio service from the APDU;

FIG. 5 is a drawing of a ticket stub or receipt that is presented to an MRD user following a ticket purchase for an audiovisual presentation;

FIG. 6 is a drawing of an audiovisual presentation system having an APDU that is configured to receive digital audio signals from a content player server CPS, according to an embodiment of the present invention;

FIG. 7 is a drawing of an audiovisual presentation system in which the processor and/or memory resources of the CPS of the audiovisual presentation system in FIG. 6 are/is used to perform some or all of the encoding and/or encrypting operations of the APDU;

FIG. 8 is a drawing illustrating how a plurality of audiovisual presentation systems, each having its own APDU, is employed in a theater complex having multiple theaters, collectively forming a audiovisual presentation multiplex or megaplex, according to an embodiment of the present invention;

FIG. 9 is a drawing of the primary components of a mobile device/MRD that is adapted to receive the wireless audio service provided by the APDU;

FIG. 10 is a drawing illustrating how a software application (i.e., “app”) for the mobile device/MRD in FIG. 9 may be downloaded from an app server configured in a local area network (LAN) or wide area network (WAN), and showing various sources (e.g., ticketing server, password/authentication server, movie information server, and merchandise web server) the mobile device/MRD may access after the app has been downloaded to the MRD;

FIG. 11 is a drawing illustrating how the app for the mobile device/MRD in FIG. 9 may be downloaded from an Internet-connected app server via a cellular network, and showing various sources (e.g., ticketing server, password/authentication server, movie information server, and merchandise web server) the mobile device/MRD may access after the app has been downloaded to the MRD;

FIG. 12 is a drawing of a home page of a graphical user interface (GUI) that is displayed by a mobile device/MRD and which provides the mobile device/MRD user the ability to, among other things, submit a password to an authenticating authority for the purpose of gaining access to the wireless audio service provided by the APDU;

FIG. 13 is a drawing of an alternative home page of a GUI that is displayed by a mobile device/MRD;

FIG. 14 is a drawing of an audio control page of the GUI that is displayed by the mobile device/MRD and which provides the mobile device/MRD user the ability to, among other things, set and adjust audio settings of the audio provided by the wireless audio service;

FIG. 15 is a drawing of a language preference and subtitles page of the GUI that is displayed by the mobile device/MRD and which provides the mobile device/MRD user the ability to, among other things, select a language preference of the audio provided by the wireless audio service;

FIG. 16 is a drawing of a movie details page of the GUI that is displayed by the mobile device/MRD and includes hyperlinks that the mobile device/MRD user can activate to, among other things, request and receive details of the movie presentation and visit websites that sell movie tickets and other movie-related and non-movie-related merchandise; and

FIG. 17 is a drawing of a gaming system having an APDU for providing a wireless audio service containing audio of an electronic game to MRD users in a gaming room or space who are equipped with MRD headsets, headphone or earbuds.

### DETAILED DESCRIPTION

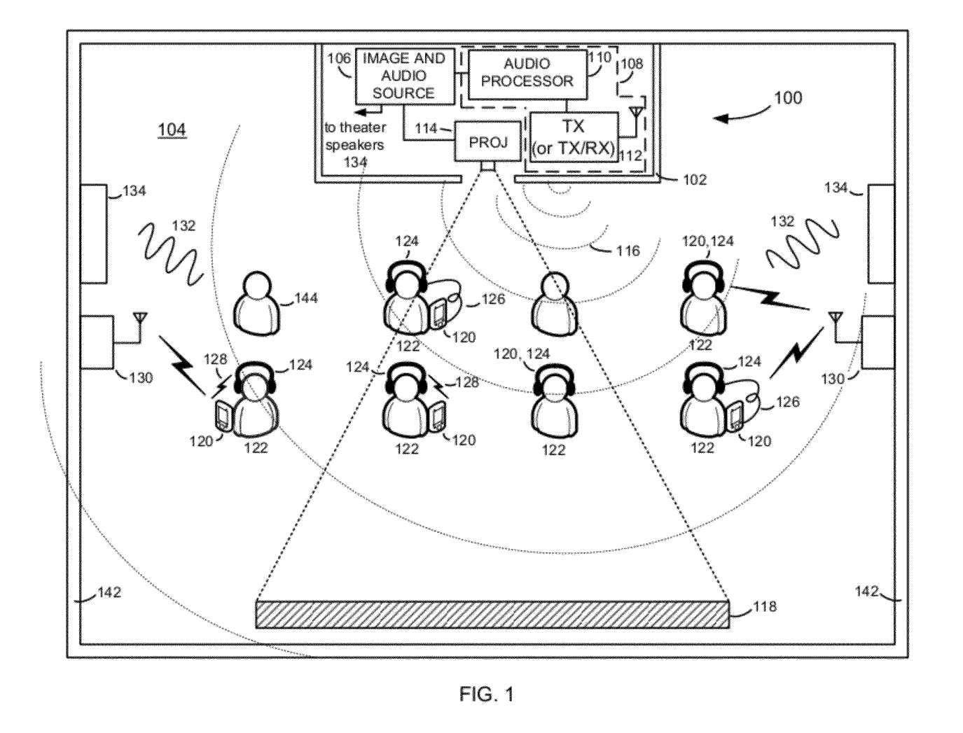

Referring to FIG. 1, there is shown an audiovisual presentation system 100 employing an audio processing and distribution unit (APDU) 108, according to an embodiment of the present invention. The APDU 108 is installed in the projection booth or audiovisual room 102 of a movie theater 104, but may be located elsewhere, and as explained in detail below includes a processor (e.g., a microcontroller, microprocessor, or other processing circuitry) that processes (i.e., encrypts, encodes and/or performs other analog and/or signal processing) audio of a movie presentation and broadcasts the processed audio throughout the theater 104 for reception by mobile receiving devices (MRDs) 120 carried or worn by MRD users 122. (Note that for the purpose of this disclosure the term “broadcast” is meant to include all forms of wireless transmissions, including analog and digital wireless transmissions, and wireless transmissions employing streaming or non-streaming wireless technologies.) Distributing audio of the movie (i.e., the soundtrack and dialogue audio) to MRDs 120 using this “wireless audio service” allows MRD users 122 to listen to and enjoy the movie soundtrack and dialogue through headsets, headphones or earbuds 124 connected to, comprising, or in communication with their MRDs 120.

Before continuing with the detailed description of the invention, it should be emphasized that although the exemplary embodiments of the invention in the description that follows is presented in the context of a movie theater 104 and for the purpose of enhancing the listening experience of movie audience members, the methods, systems and apparatus of the present invention may be used in other venues, public or private, and to provide wireless audio services in other presentations besides movie presentations. For example, the methods, systems and apparatus of the present invention may be used to, among other things: distribute audio of an audiovisual presentation, whether it be a movie or other audiovisual presentation, to MRD users 122 in multiple languages; improve the ability of MRD users 122 who are hearing impaired to listen to and comprehend audio of an audiovisual presentation; provide audio descriptions of an audiovisual presentation to MRD users 122 who are visually impaired; and enhance the listening experience of MRD users 122 who are gamers participating in an electronic gaming event or competition. Therefore, unless the language of a particular claim explicitly limits the invention to a movie theater or movie presentation, the scope of the invention should not be construed as being so limited.

Referring back now to FIG. 1, when the audiovisual presentation system 100 is configured for use in a movie presentation, audio signals of the movie being presented are directed from an image and audio source 106 to the APDU 108. The APDU 108 includes an audio processor 102 comprising an analog, digital or analog and digital processor implemented in hardware or combination of hardware and software. The audio processor 102 is configured to process or provide instructions for processing the movie audio to produce the aforementioned encrypted and/or encoded audio signal. The APDU 108 further includes a wireless transmitter (TX) 112 (or transceiver TX/RX) that modulates the encrypted and/or encoded audio signal onto a wireless carrier and broadcasts the modulated wireless carrier 116 throughout the theater 104. Meanwhile, images from the image and audio source 106 are projected by the projector 114 onto a projection screen 118, which is viewed by the MRD users 122 and other audience members.

MRDs 120 carried or worn by MRD users 122 receive and demodulate the modulated audio carrier 116, and decrypt and/or decode the encrypted and/or encoded audio signal, allowing corresponding MRD users 122 to listen to the movie soundtrack and dialogue audio provided by the wireless audio service through headsets, headphones or earbuds 124 that connect to the MRDs 120 via headset cable 126 or Bluetooth link 128. To improve the distribution of the modulated audio carrier 116 to faraway, recessed or shielded areas of the theater 104, additional wireless repeaters, base stations, or access points (APs) 130 may be installed throughout the theater 104.

Distribution of the wireless audio service may also be controlled to extend beyond the theater walls 142 for a short distance, allowing MRD users 122 to continue using the wireless audio service even if they have to leave the theater 104 for a short time, for example, to visit the theater concession stand or use the theater restroom.

Audience members who do not have MRDs 120, like audience member 144, and audience members who have MRDs 120 but are not authorized or otherwise able to access or receive the wireless audio service, listen to the movie soundtrack and dialogue in the conventional manner, i.e., by listening to sound waves 132 produced by theater speakers 134.

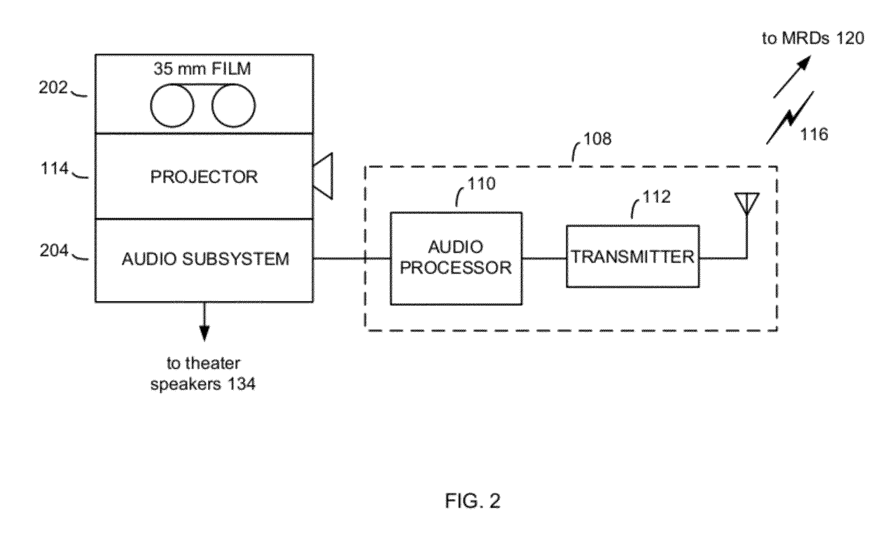

The image and audio source 106 for the audiovisual presentation system 100 may be an analog, digital or combined analog/digital source. In one embodiment of the invention illustrated in FIG. 2, the image and audio source comprises standard 35 mm film 202 or 35 mm film and a separate compact disc read-only memory (CD-ROM) or other nonvolatile storage device as the audio source. Images from the film 202 are projected onto the projection screen 118 by the projector 114 and digital audio signals derived from the film 202 (or provided by the CD-ROM) are directed to the theater audio subsystem 204.

In one embodiment of the invention the APDU 108 is physically and permanently connected to or integrated within the theater audio subsystem 204. In an alternative embodiment, shown in FIG. 2, the APDU 108 comprises a separate, self-contained unit 108 that is releasably connected to the audio subsystem 204, using standard RCA cables, a fiber-optic cable, or other digital or analog cables.

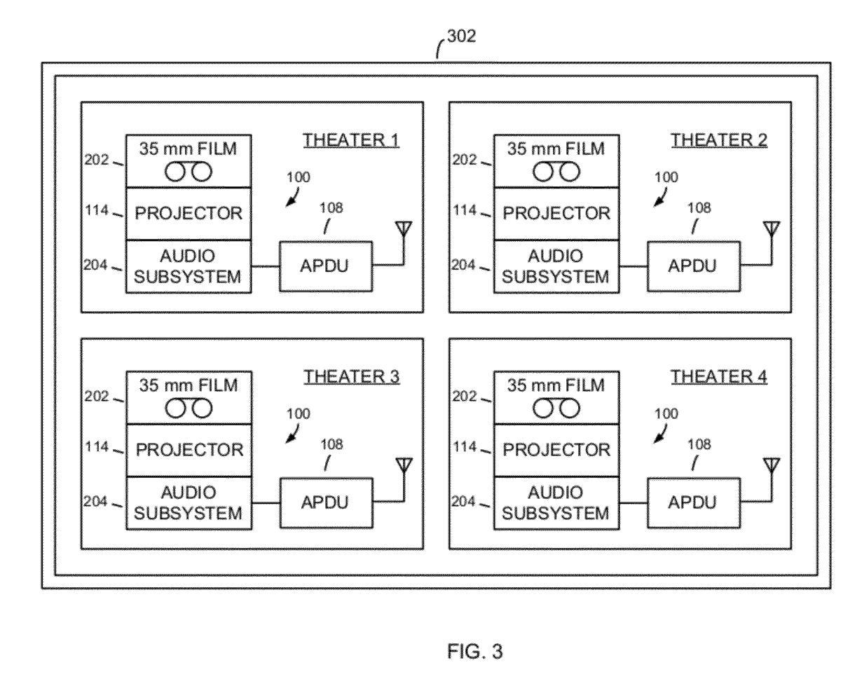

According to one embodiment of the invention illustrated in FIG. 3, a plurality of APDUs 108 is configured in a theater multiplex (or megaplex) 302 comprising a plurality of theaters (e.g., Theater 1, Theater 2, Theater 3 and Theater 4) that present a plurality of different audiovisual presentations. The audiovisual presentation system 100 in each theater includes its own APDU 108, which is connected to the audio subsystem of the associated audiovisual presentation system 100, similar to as described above in reference to FIG. 2. The transmitter 112 of each APDU 108 is configured to broadcast at a specific frequency, to which receivers of MRDs 120 in the associated theater tune to in order to receive the wireless audio service in the associated theater. In one embodiment of the invention the transmitters 112 of the APDUs 108 comprise frequency modulation (FM) transmitters. Each FM transmitter 112 is configured to broadcast its wireless audio service at a fixed, specific frequency in an licensed or unlicensed frequency band of the radio frequency spectrum, and the MRDs 120 include FM receivers capable of tuning to the specific frequency at which the APDU 108 broadcasts the wireless audio service, either manually by the MRD users 122 or automatically under the direction of a software application installed on the MRDs 120 (explained in more detail below). To limit transmission to within or shortly beyond the theater or multiplex boundaries and/or to comply with maximum transmit power requirements enforced by regulatory bodies, the transmit powers of the FM transmitters of the APDUs 108 are configured to transmit at power levels that satisfy the boundary conditions and/or do not exceed the regulatory body maximum transmit power specifications.

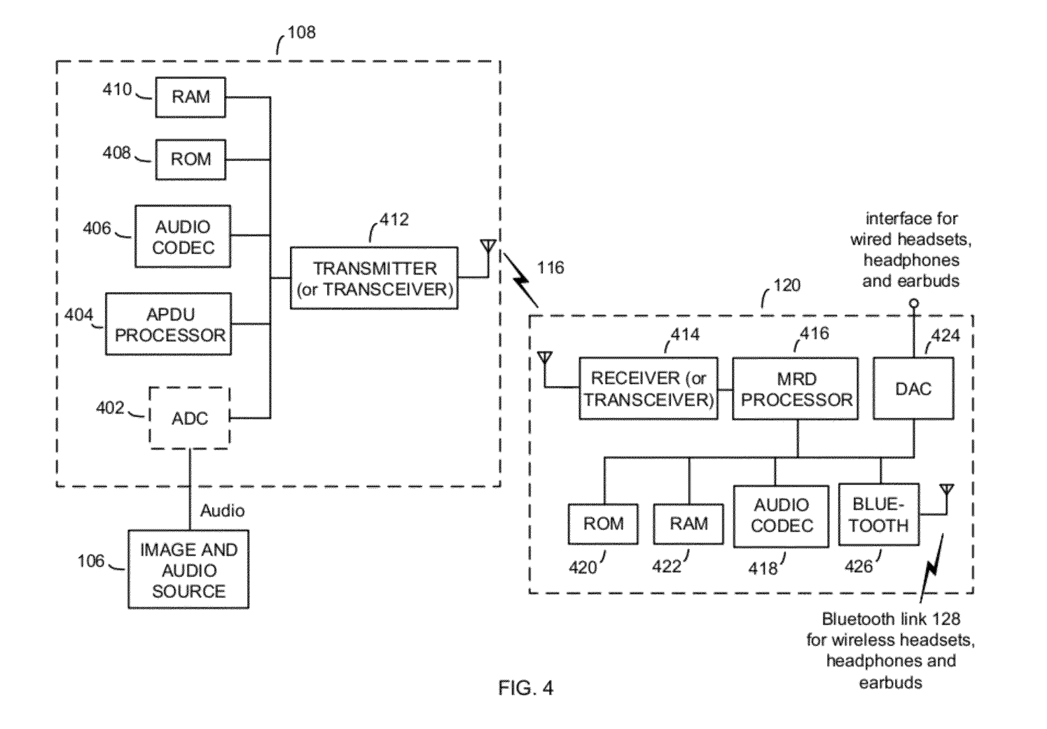

FIG. 4 is a drawing showing further details of how one embodiment of the APDU 108 generates and broadcasts the encrypted and/or encoded audio signal to one of the MRDs 120 in a given theater. The APDU 108 includes an optional analog-to-digital converter (ADC) 402, an APDU processor 404, an audio codec 406, read only memory (ROM) 408, random access memory (RAM) 410, and a wireless transmitter (or transceiver) 412.

The ADC 402 is included and used if the audio signals from the image and audio source 106 are not already in digital form. Otherwise, it is not needed.

The audio codec 406 comprises a circuit (i.e., hardware), software or combination of hardware and software, and in one embodiment comprises software (i.e., a computer program or computer-readable code) stored in ROM 408 or other nonvolatile memory of the MRD 120 such as flash memory or a hard drive. When used, the APDU processor 404 loads the audio codec 406 into RAM 410 and encodes, encrypts and/or enhances the digital audio signal according to the instructions specified by the audio codec 406. The transmitter 412 then modulates the resulting encrypted and/or encoded digital audio signal onto a wireless carrier and broadcasts the final modulated wireless carrier 116 throughout the theater 104 for reception by MRDs 120.

The wireless transmitter 412 may comprise any type of wireless transmitter capable of broadcasting the wireless audio service throughout the theater 104. It may alternatively comprise a transceiver having a transmitter for transmitting the modulated wireless carrier 116 to the MRDs 120 and a receiver for receiving signals from the MRDs 120. As previously explained, in one embodiment of the invention the transmitter 412 comprises an FM transmitter configured to transmit in a licensed or unlicensed frequency band of the radio frequency spectrum and at a power level in compliance with power specifications promulgated by regulatory bodies, such as the Federal Communications Commission (FCC) in the United States. Subcarriers or sidebands of the FM carrier may also be used to carry secondary language support and/or audio or text subtitles for display on MRDs 120 equipped with displays.

In another embodiment of the invention, the wireless transmitter 412 comprises a wireless access point (AP) of a wireless router, and the APDU 108 is configured in a wireless local area network (LAN), for example, a Wi-Fi network. According to that alternative embodiment, different language audio and subtitles are multiplexed with the primary digital audio data transmitted or streamed over the wireless LAN to the MRDs 120. MRD users 122 use a software application installed on their MRDs 120 to select and receive the movie audio and/or text subtitles in their preferred language. Further details of that alternative embodiment of the invention are provided below.

Compared to one another the MRDs 120 may have somewhat different physical, hardware and/or software configurations, but as illustrated in FIG. 4 each MRD 120 generally includes a receiver 414 (or transceiver), MRD processor 416, audio codec 418, ROM 420, RAM 422 and digital-to-analog converter (DAC) 424. Though not shown in the drawing, an MRD may also include nonvolatile storage such as flash memory or a hard drive. Further, MRDs 120 may include a Bluetooth transceiver 426 or other type of personal area network transceiver for use with Bluetooth headsets, headphones or earbuds.

The receiver 414 of an MRD 120 is configured to receive the modulated wireless carrier 116 broadcast from the APDU 108 and downconvert it to baseband. The MRD processor 416 decodes and decrypts the downconverted baseband signal, to recover the enhanced audio signal that was generated by and transmitted from the APDU 108. Similar to the audio codec 406 of the APDU 108, the audio codec 418 of the MRD 120 comprises hardware, software or combination of hardware and software. In one embodiment, the audio codec 418 comprises a software program (i.e., computer-readable code) that is stored in ROM 420 or other nonvolatile memory of the MRD 120 such as flash memory or a hard drive. When the audio codec 418 is used, the MRD processor 416 loads it into RAM 422 and decodes and decrypts the downconverted baseband signal according to the audio codec 418 specifications, to recover the enhanced audio generated and transmitted from the APDU 108. The DAC 424 converts the recovered enhanced digital audio into an analog signal which is coupled to an output interface (e.g., an audio jack) of the MRDs 120. An MRD user 122 connects their wired headsets, headphones or earbuds 124 to the output interface to access audio provided by the wireless audio service. Alternatively, for a Bluetooth-enabled MRD 120, the recovered enhanced digital audio signal is directed to the MRD's 120's Bluetooth transceiver 426, where it is upconverted and communicated over a Bluetooth link 128 to the MRD user's 122's Bluetooth headset, headphones or earbuds.

In one embodiment of the invention, MRD users 122 are able to access the wireless audio service provided by the APDU 108 only if their MRDs 120 are authorized and equipped to receive the service. It should be emphasized, however, that authorization is not required in all embodiments of the invention. For example, in one embodiment of the invention, access to the wireless audio service is accomplished simply by tuning the receiver of the MRD 120 to the frequency at which the APDU 108 is broadcasting the wireless audio service. In another embodiment, a software application that has been downloaded and installed on an MRD user's 122's MRD 120 provides instructions to the MRD's 120's central processing unit to automatically tune the MRD's 120's FM receiver to the frequency at which an FM transmitter of the APDU 108 broadcasts. In that particular embodiment, all that is required to access the wireless audio service is the downloading and installation of the software application. No authorization, other than perhaps paying a fee to download and install the software application is required to access the wireless audio service.

For embodiments of the invention in which authorization is required to gain access to the wireless audio service, various techniques for controlling and regulating access may be employed. In one embodiment of the invention, for example, MRD users 122 are able to access and use to the wireless audio service provided by the APDU 108 only if the audio codec 418 is present and enabled on their MRDs 120. To prevent unauthorized access to the wireless audio service, the audio codec 418 remains disabled or is prevented from being downloaded to an MRD user's 122's MRD 120 until the MRD demonstrates to an authenticating authority that a movie ticket or software application for controlling features of the wireless audio service (explained in more detail below) has been purchased. The authenticating authority may be a human or machine. For example, it may comprise a computer (i.e., a machine) configured in a LAN or wide area network (WAN) to which MRDs 120 or MRD users 122 submit access permission requests or other authenticating information, via a wireless link (e.g., Wi-Fi or cellular wireless link).

Authorization by the authenticating authority may take place automatically by the MRDs 120 or manually, for example in response to passwords submitted by MRD users 122 through a user interface of their MRDs 120. In one embodiment of the invention authorization is automatically performed by an MRD 120 when an MRD user 122 purchases a movie ticket online, e.g., from an online ticketing vendor such as a ticketing server connected to the Internet. According to this approach, the audio codec 406 in the APDU 108 is configured to employ a public-key encryption algorithm, which encrypts the digital audio signal from the image and audio source 106 as well as encrypting a master (i.e. “public”) key. The encrypted digital audio signal and encrypted master key are broadcast by the APDU's 108's transmitter 412 throughout the theater 104. However, only those MRDs 120 having a matching user (i.e., “private”) key are able to decrypt the encrypted master key and encrypted digital audio. An authorized MRD 120 acquires a user key upon the MRD user 122 completing a valid online ticket purchase. Upon completing a valid online ticket purchase, a ticketing server (e.g., a local server or remote server connected to the Internet) generates a user key, which the authorized MRD 120 downloads separate from or along with the audio codec 418. Once downloaded and installed, the authorized MRD 120 uses the user key to decrypt the master key, thereby allowing the audio codec 418 to decrypt the encrypted digital audio signal received from the APDU 108. The above-described encryption/decryption method is an asymmetric encryption algorithm, and only one of various ways in which access to the wireless audio service can be controlled. Other encryption/decryption algorithms, symmetric or asymmetric, and other automatic authentication methods for controlling access to the wireless audio service may be used, as will be appreciated and understood by those of ordinary skill in the art.

Authorization to access the wireless audio service provided by an APDU 108 may be alternatively performed manually, requiring MRD user 122 input. In one embodiment of the invention a password is generated and issued to an MRD user 122 following a ticket purchase by the MRD user 122. The password may only be used for the movie presentation for which the ticket is purchased and remains valid only for the duration of the presentation. The MRD user 122 submits the password through a user interface of their MRDs 120 to the authenticating authority, which upon validating the password grants permission to the submitting MRD 120 to download and enable the audio codec 418 (or activate the audio codec 418 if it has already been downloaded and installed).

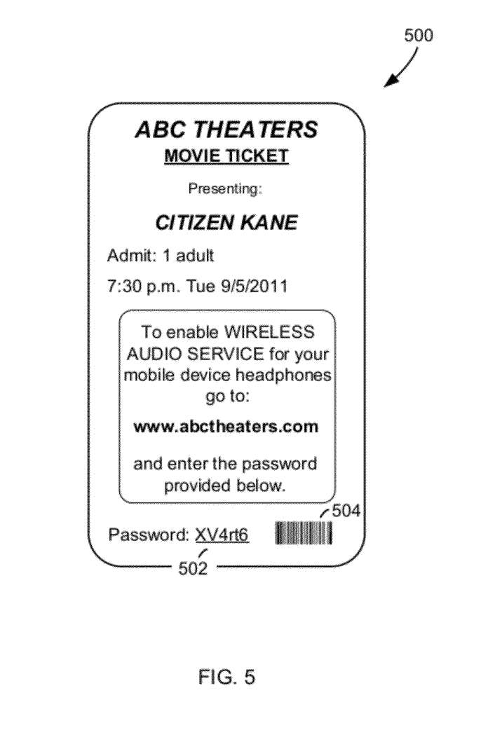

Passwords can be generated and issued to MRD users 122 in various ways. In one approach each MRD user 122 receives a unique ticket stub or receipt 500 containing a password 502, similar to as illustrated in FIG. 5, after completing a ticket purchase. For example, following an online ticket purchase (i.e., for a ticket purchased over the Internet from the theater website or third-party ticket vendor website), a ticketing server generates a ticket stub or receipt 500 having a unique password. The ticketing server transmits an electronic version of the ticket stub or receipt 500 to the MRD user's 122's computer or MRD 120, or in an email to an email host that hosts the MRD user's 122's email. The MRD user 122 then prints the ticket stub or receipt 500 using a printer before traveling to the theater 104. Upon arriving at the theater 104, the MRD user 122 uses the printed-out ticket stub or receipt 500 to gain entrance, and uses the password 502 printed thereon to gain access to the wireless audio service provided by the APDU 108. For in-theater (i.e., in-person) ticket purchases, ticket stubs or receipts 500 are generated either locally or remotely and printed locally by an in-theater ticketing printer.

Passwords generated by the ticketing server or in-theater ticketing computer are also securely transmitted to the authenticating authority. To enable access to the wireless audio service from the APDU 108, an MRD user 122 enters the unique password 502 printed on their ticket stub or receipt 500 manually through a web form of a web browser of the MRD 120, or manually through a graphical user interface (GUI) presented by a special software application previously installed on the MRD 120. The MRD 120 transmits the entered password to the authenticating authority for validation. Other manual authentication approaches using and not using passwords may be employed. For example, for MRDs 120 equipped with the ability to read or scan barcodes or other machine-readable information, the ticket stub or receipt 500 may include a barcode 504 or other machine readable identifier, which when read or scanned by the MRD 120 is submitted to the authenticating authority for validation.

In addition to the audio codec 406 of an APDU 108 being configured to encrypt the digital audio from the image and audio source 106, it may further include an audio encoder for encoding the digital audio, either prior to or after the digital audio has been encrypted. Like the other components of the audio codec 406, the audio encoder may comprise hardware, software or a combination of hardware and software. In one embodiment of the invention the audio encoder comprises software instructions executed by the APDU processor 404 that encode the digital audio in accordance with a psychoacoustic compression algorithm such as MP3, Ogg Vorbis, SPEEX or FLAC, or other sound-enhancing process that produces stereo, surround or other multi-dimensional or multi-channel sound effects for enhancing the listening experience of the MRD users 122.

The audio codecs 418 of the MRDs 120 include complementary decoders, which operate to decode the digital audio encoded by the encoder of the APDU's 108's audio codec 406. Unauthorized MRDs 120 may be prevented from decoding the encoded digital audio, either by preventing the audio codec 418 from being installed or downloaded to the MRDs 120, or by preventing the audio codec 418 from working if already installed on the MRD 120. The same or similar techniques to those described above for granting and denying decryption rights may be used to grant and deny the ability to decode the encoded digital audio signals.

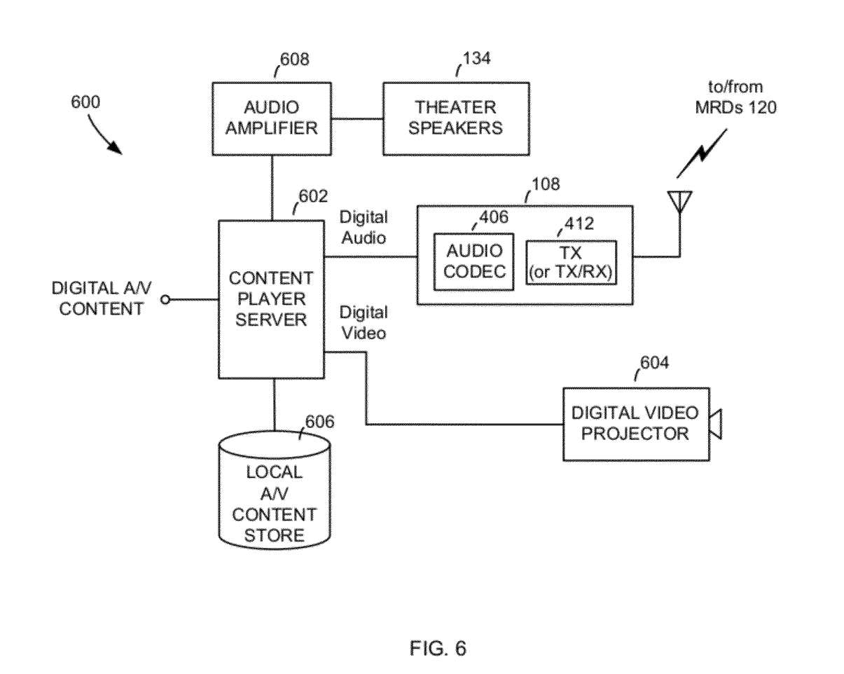

In the exemplary audiovisual presentation system 100 shown and described above in reference to FIGS. 1 and 2, the APDU 108 is configured to receive digital audio signals from standard 35 mm film 202, or from a separate digital audio source such as a CD-ROM. FIG. 6 shows an alternative audiovisual presentation system 600 in which the APDU 108 is configured to receive digital audio signals from a content player server (CPS) 602. The CPS 602 comprises hardware, software or combination thereof, and in one embodiment of the invention comprises a combination of hardware and software. The CPS 602 is configured to perform various functions: including: receiving digital audio and video (AN) content from a digital A/V source, such as a centrally-managed A/V media management server and media database, digital video disk (DVD), Blu-ray disc, flash drive, etc.; decoding and decrypting the digital A/V content before sending it to the APDU 108, if necessary; providing decoded and decrypted digital audio and video signals to the APDU 108 and digital video projector 604; and receiving and responding to requests from MRDs 120 for language preferences, subtitles, movie details, and requests to purchase movie-related merchandise. The CPS 602 may be further configured to perform the functions of the authenticating authority, including receiving and validating passwords submitted by MRDs 120 requesting access to the wireless audio service provided by the APDU 108.

Decrypted and decoded digital audio produced by the CPS 602 are directed to the APDU 108, which encodes, encrypts and/or enhances the digital audio signals and modulates the resulting encrypted and/or encoded digital audio signals onto a wireless carrier, similar to as described above. The digital video projector 604 projects images of the movie being presented on the projection screen 118 using the digital video signals from the CPS 602. (Other display means besides image projection may be used to display the movie images, such as a liquid crystal (LCD), light-emitting diode (LED), organic LED, or plasma technology display or monitor.)

As illustrated in the drawing (FIG. 6), the audiovisual presentation system 600 may further include a local A/V content store 606 that functions as a local image and audio source and/or language and subtitle source, as well as an audio amplifier 608 for amplifying audio signals from the CPS 602 for the theater speakers 134.

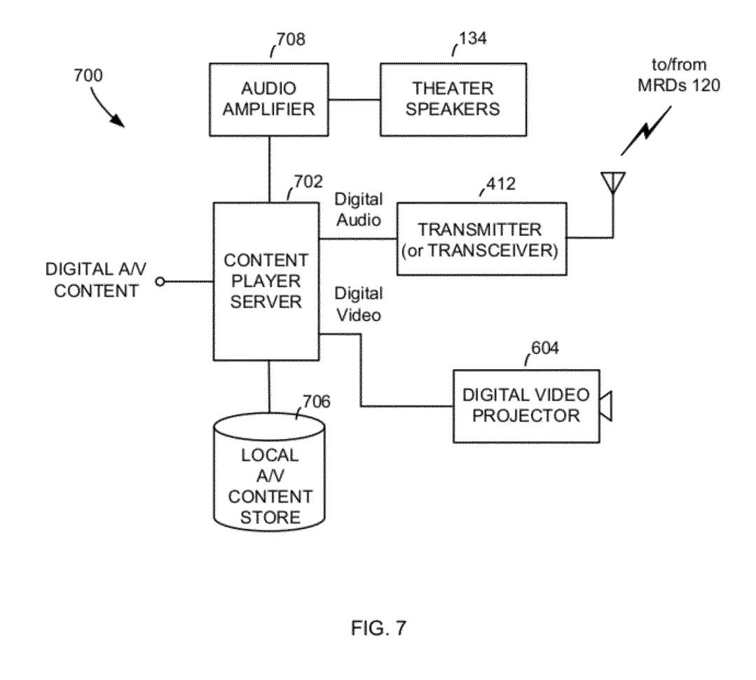

It should be mentioned that because the CPS 602 has ROM and RAM and a processor, those memory and processing resources may be used to store the audio codec 406 and perform some or all of the encoding and encrypting processing functions specified by the audio codec's 406's software instructions. As illustrated in FIG. 7, which is a drawing of an alternative audiovisual presentation system 700, sharing the CPS's 602's resources in this manner can reduce the complexity of the APDU hardware and software since the memory and some or all of the audio processing functions of the APDU 108 can be performed by the CPS 602.

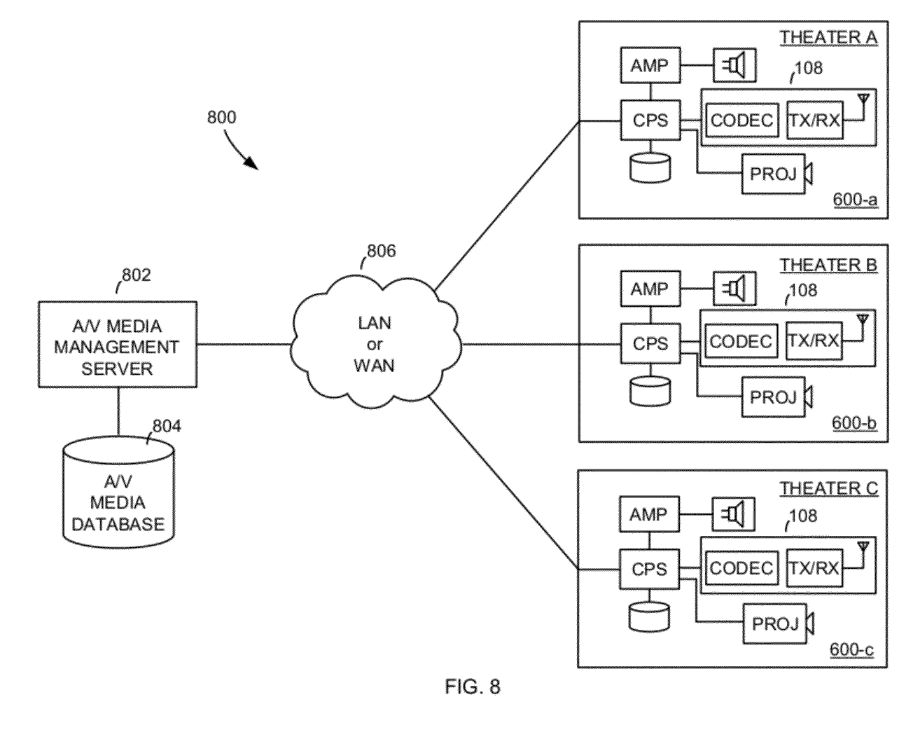

FIG. 8 is a drawing illustrating how a plurality of audiovisual presentation systems 600-a, 600-b and 600-c, each having its own APDU 108, is employed in a theater complex having multiple theaters, collectively forming a audiovisual presentation multiplex or megaplex 800. The multiple audiovisual presentation systems 600-a, 600-b and 600-c are configured to communicate with a centralized A/V media management server 802, via a LAN or WAN 806. The A/V media management server 802 is located in a media management office in the theater complex or other remote location, and comprises a combination of hardware and software configured to generate multiple audio and video digital signals from digital A/V content retrieved from an A/V media database 804. Like the A/V media management server 802, the A/V media database 804 is located in the theater complex's media management office or at a remote location. A router (not shown) routes the multiple digital audio and video signals to the CPSs 602 of the multiple audiovisual presentation systems 600-a, 600-b and 600-c in theaters A, B and C, respectively.

Note that the A/V media management server 802 may be further configured to perform some or all of the processing functions of the APDUs 108 and/or CPSs 602 of the audiovisual presentation systems 600-a, 600-b and 600-c, thereby obviating the need for separate audio processing hardware for the APDUs 108 and CPSs 602. The A/V media management server 802 and/or the CPSs 602 may also be configured to perform digital rights management functions relating to preventing unauthorized copying or duplication of the digital movie media.

Access to the wireless audio services provided by the APDUs of the multiple audiovisual presentation systems 600-a, 600-b and 600-c is controlled by granting or denying MRDs 120 permission to join the network in which the multiple audiovisual presentation systems 600-a, 600-b and 600-c are configured. Access control is performed by the CPSs 602 individually, the A/V media management server 802, or both, or by any other suitable access control mechanism. Each of the multiple audiovisual presentation systems 600-a, 600-b and 600-c is configured in a primary LAN, its own unique LAN, or a subnetwork of a primary LAN, and in one embodiment of the invention MRDs 120 join the network in a given theater (Theater A, B or C) by submitting the correct network access password. MRD users 122 enter the network passwords through a web form of a web browser of the MRD 120, or the GUI of a software application or plug-in that has been previously downloaded to the MRD 120, which transmits the entered password to the CPS 602, A/V media management server 802, or dedicated password authenticating server for validation. With the correct network password entered, a MRD 120 is authenticated and allowed to receive the wireless audio service. Otherwise, access to the service remains unavailable. It should be mentioned that this method of authenticating MRDs 120 does not require but may incorporate the downloading and enabling of audio codecs to the MRDs 120. Further, this method of authenticating MRDs 120 may be used independent of or in conjunction with other authentication mechanisms, including any one of the authentication methods described herein.

As explained above, each MRD 120 includes a wireless receiver (or transceiver) 414 and audio processing software and/or hardware needed to decode and decrypt the encrypted and/or encoded audio received from the APDU 108. In one embodiment of the invention the MRDs 120 comprise self-contained processing and receiving units (i.e., “receiver boxes”) that include the wireless receiver 414 and the audio processing software and/or hardware. A receiver box includes an audio output port (e.g., a 3.5 mm audio output jack) to which MRD users 122 connect their headsets, headphones or earbuds to access and use the wireless audio service provided by the APDU 108. In another embodiment the MRDs 120 comprise special-purpose wireless headsets, headphones or earbuds that contain the wireless receiver 414 and audio processing software and/or hardware (rather than packaging the wireless receiver 414 and the audio processing software and/or hardware in a separate receiver box). Similar to the other mobile devices/MRDs described below, the special-purpose wireless headsets may include, in addition to the sound-enhancing software and/or hardware, hardware and/or software that automatically links to the APDU 108 or tunes to the frequency at which the APDU 108 broadcasts. MRD users 122 may purchase, borrow or rent the receiver boxes or special-purpose wireless headsets, headphones or earbuds at the theater from theater attendants, purchase them from a third party, or obtain them for free, for example through promotional offers.

In one implementation of the invention the MRDs 120 comprises cell phones, smart phones, personal digital assistants (PDAs), digital audio players, or other mobile device carried by the MRD users 122. In this implementation one of the FM, Wi-Fi or Bluetooth receivers or transceivers built into the mobile device serves as the wireless receiver for receiving the wireless audio service from the APDU 108. Which receiver in the mobile device is used depends on which type of transmitter technology (FM, Wi-Fi or Bluetooth) the transmitter 412 of the APDU 108 employs.

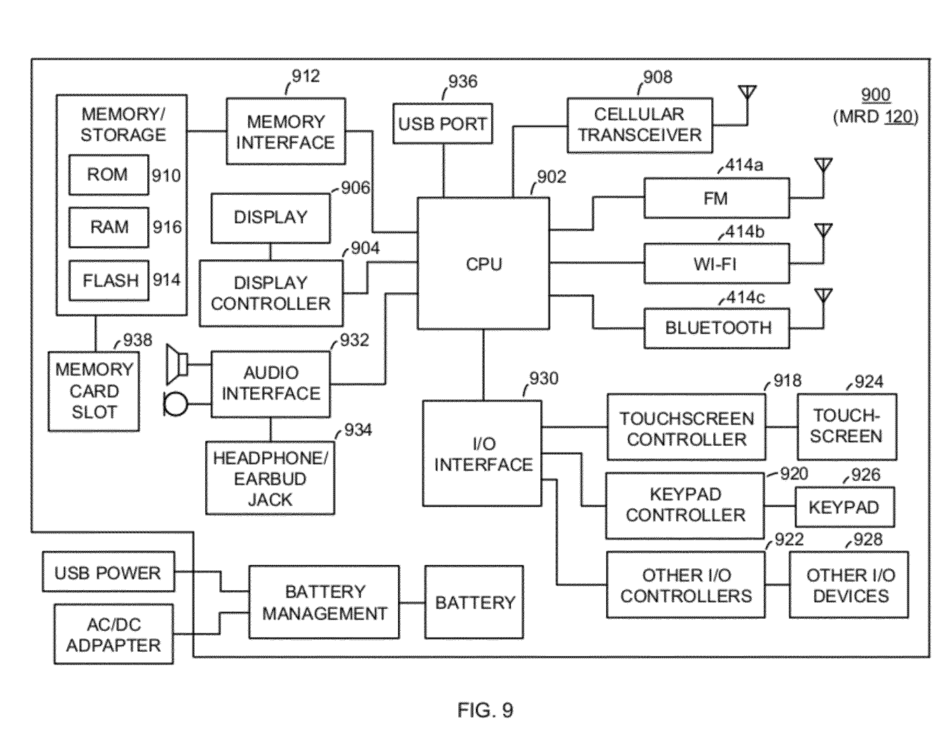

As illustrated in FIG. 9, the FM, Wi-Fi and/or Bluetooth receivers (or transceivers) 414a, 414b or 414c of the mobile device 900 are enabled and controlled by a central processing unit (CPU) 902. The CPU 902 is also configured to perform other routine and non-routine functions. Routine functions include functions such as: controlling the display controller 904 of the mobile device's display 906; processing baseband signals for the mobile device's cellular transceiver 908; reading basic input-output system (BIOS) and other system control data from ROM 910, via a memory interface 912; storing and purging files, applications and other data in and from flash memory 914; loading and removing files, applications and other data into and from RAM 916; and providing and receiving input and output (I/O) control signals for the touchscreen controller 918, keypad controller 920 and other I/O controllers 922 of the mobile device's 900's touchscreen 924, keypad 926 and other I/O devices 928, via an I/O interface 930.

Non-routine functions performed by the CPU 902 and salient to the present invention, include, but are not limited to: facilitating the download of the audio codec 418 and storage into flash memory 914 of the mobile device 900/MRD 120 (once the mobile device 900/MRD 120 is authorized to download and use the audio codec 418, as discussed above); tuning one of the FM, Wi-Fi and/or Bluetooth receivers 414a, 414b or 414c to the frequency of an APDU 108, decoding and/or decrypting the encrypted and/or encoded audio received by one of the FM, Wi-Fi and/or Bluetooth receivers 414a, 414b or 414c from the APDU 108; and directing the resulting decoded, decrypted and/or enhanced audio signal to an audio interface 932 and headphone/earbud jack 934 for the MRD user's 122 wired headset, headphones or earbuds.

Typically a mobile device 900/MRD 120 will also include a USB port 936, which the MRD user 122 may use to connect to the USB port of a computer (e.g., a laptop or desktop computer) that stores or has access to the audio codec 418, thereby allowing the audio codec 418 to be transferred to the mobile device's flash memory 914 (or other nonvolatile storage device, such as a hard drive, if the mobile device 900 is so equipped). The audio codec 418 may be alternatively transferred to the flash memory 914 via a wireless connection to a remote server or from a nonvolatile memory card designed to plug into a memory card slot 938 of the mobile device 900.

According to one embodiment of the invention, the mobile device 900/MRD 120 is equipped with a software application (i.e., “app”), which the CPU 902 executes and the MRD user 122 interacts with to, among other things: activate and control features of the wireless audio service from the APDU 108; set language preference and subtitle settings of the audio provided by the wireless audio service; request details of the movie being presented; purchase movie-related merchandise; and/or link to marketing and/or promotional websites. The app may be platform-independent or designed and adapted specifically for use on MRDs 120 employing a particular mobile operating system (OS), such as a Unix or Linux-based OS like Google Android and Apple iOS, Symbian OS, Blackberry OS, or Microsoft Windows Phone OS. Further, the app may be a self-contained computer program capable of running independently of other applications, or may comprise a plug-in or set of software components designed to operate in or in cooperation with a larger application such as, for example, a web browser or a mobile media player.

In one embodiment of the invention the app comprises software that may be downloaded from an Internet-based app server (or “app store”), such as Apple's App Store, Google's Android Market, Microsoft Windows Marketplace for Mobile app stores, etc., either for a fee or for free. The app may be configured so that it is useable for multiple audiovisual presentation events (e.g., by paying for a monthly or annual subscription) or only for a single particular audiovisual presentation event (i.e., “pay-per-use”). For example, in the case of pay-per-use, the app may include built-in timer instructions that cause the app to become nonoperational and/or the wireless audio service inaccessible following a predetermined duration of time after the app has been downloaded and installed on the mobile device 900/MRD 120.

In another embodiment of the invention, the ability to download and/or install the app on MRDs 120 is conditioned upon proof-of-ticket-purchase from MRDs 120 or MRDs 120 and MRD users 122. Limiting download and/or installation rights to those MRD users 122 who have purchased a ticket provides another mechanism by which MRD users 122 can be granted or denied access to the wireless audio service provided by the APDU 108. For example, MRD users 122 who purchase their movie tickets online are granted permission to download the app and audio codec 418 to their MRDs 120, whereas MRD users 122 who do not purchase their tickets online are unable to download the app and audio codec 418 or are required to obtain the app and audio codec 418 by other means.

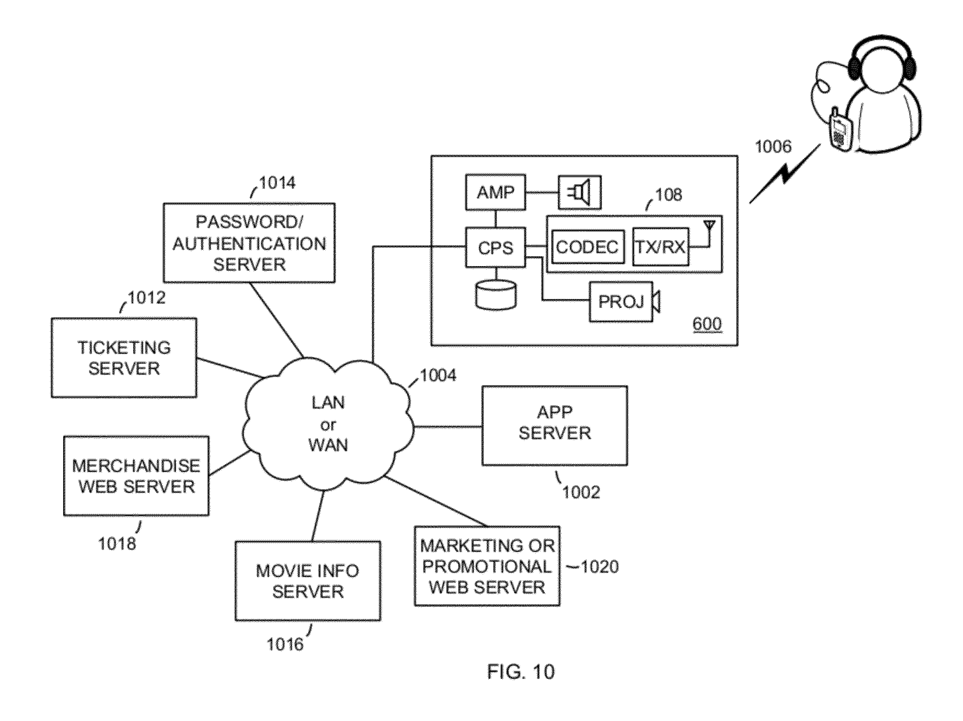

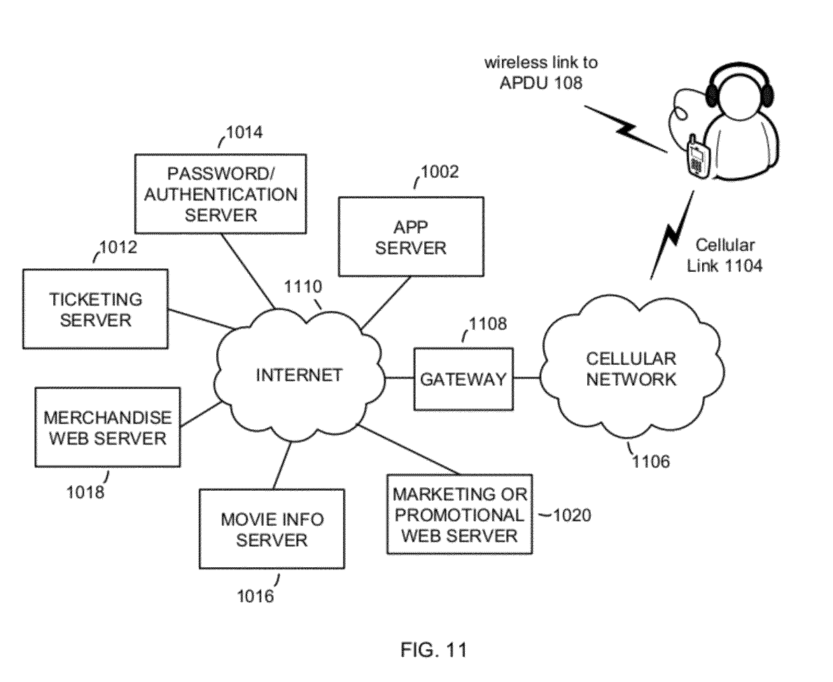

The app may be downloaded or transferred to the MRDs 120 in various ways and from various sources. As explained above, it may be download from an app server 1002 connected to a LAN or WAN 1004, for example via a wireless link 1006 between the MRD 120 and transceiver of the APDU 108, as illustrated in FIG. 10. Alternatively, it may be downloaded from an Internet-connected app server 1002 over a cellular link 1104, via a cellular-to-Internet gateway 1108 between the Internet 1110 and a cellular network 1106, as illustrated in FIG. 11.

Rather than downloading the app from a computer, the app may be transferred to the flash memory 914 or RAM 916 of the mobile device 900/MRD 120 from a computer-readable medium comprising a hard disk, optical disk, magneto-optical disk, RAM, ROM, magnetic or optical cards, flash memory card, or other memory or storage device.

Once the app is installed on the mobile device 900/MRD 120, it facilitates access to other sources and resources, such as a ticketing server 1012, password/authentication server 1014, movie information server 1016, merchandise web server 1018, as illustrated in FIGS. 10 and 11. The app may also include instructions that cause the CPU 902 to collect data from the MRD user's 122's interaction with the app, and/or instructions for linking to consumer and business web servers for data capture, marketing and/or promotional purposes, such as the marketing or promotional web server 1020 shown in FIGS. 10 and 11.

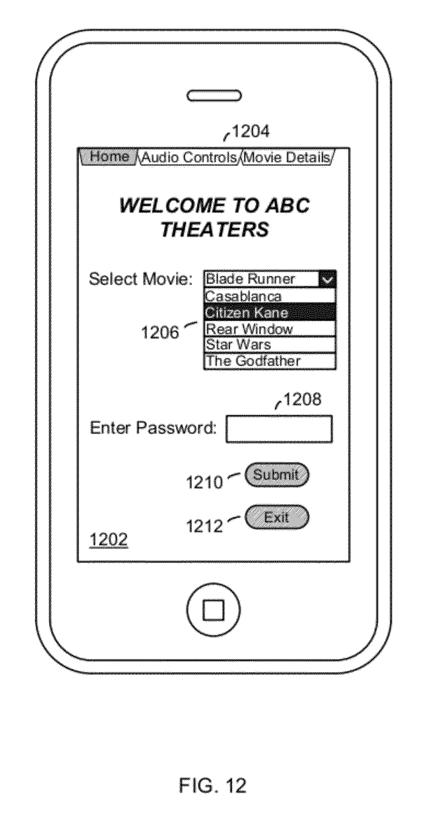

In one embodiment of the invention, illustrated in the drawings in FIGS. 12-16 below, the app provides instructions that cause the CPU 902 of the mobile device 900/MRD 120 to provide a GUI on the display 906 of the mobile device 900/MRD 120. FIG. 12 is a drawing of the GUI home page 1202. The GUI home page 1202 includes various user controls, such as page tabs 1204, drop-down movie list of movies being presented 1206, password box 1208, and SUBMIT and EXIT buttons 1210 and 1212. The password box 1208 is used for those embodiments of the invention in which a password is required to access the wireless audio service provided by the APDU 108, for example for MRD users 122 who have purchased their tickets in person or for other circumstances in which manual authentication is used. As explained above, the password is submitted to an authenticating authority (e.g., the remote password/authentication server 1014 in FIG. 9 or 10), which validates the password and authorizes the submitting MRD 120 to: download and enable the audio codec 418, activate the audio codec 418 if it is already installed in the MRD 120 or, for networked audiovisual presentation systems (such as the audiovisual presentation multiplex or megaplex 800 in FIG. 8), gain permission to join a secure wireless network within which the APDU 108 is configured to broadcast the wireless audio service.

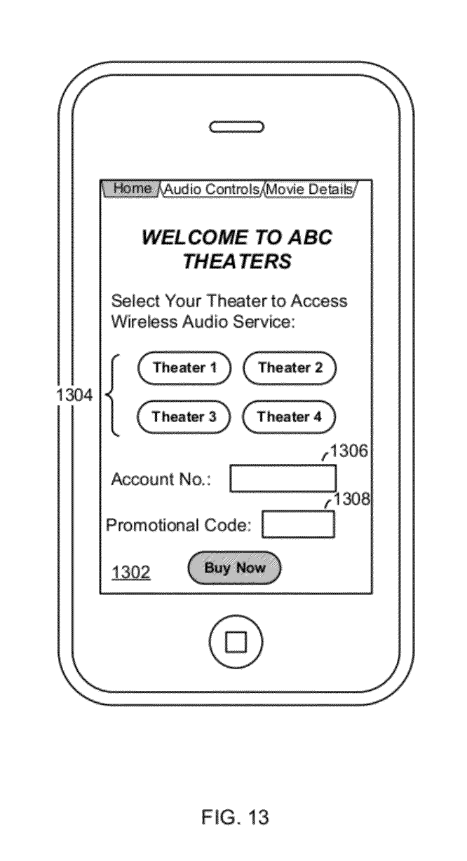

FIG. 13 is a drawing of an alternative GUI home page 1302, which the app and CPU 902 are alternatively configured to display for those embodiments of the invention in which a password or other mechanism of authentication is not required to access the wireless audio service. The GUI home page 1302 includes controls 1304 corresponding to a plurality of different wireless audio services being provided in a plurality of different movie theaters (e.g., Theater 1, Theater 2, Theater 3 and Theater 4) of a theater multiplex (or megaplex). MRD users 122 simply select the control 1304 corresponding to the theater in which their movie presentation is being presented to access the appropriate wireless audio service. In embodiments of the invention in which the transmitter 412 of the APDU 108 is configured to broadcast at a specific FM frequency, the app further includes instructions that, in response to the MRD user's theater input selection, cause the CPU 902 of the mobile device 900/MRD 120 to automatically tune an FM transmitter in the mobile device 900/MRD 120 to that particular FM frequency.

In embodiments of the invention in which MRD users 122 must first pay a fee to activate the app and access the wireless audio service, an account number box 1306 that links to a theater vendor or app store may also be provided as part of the home page GUI. Upon the MRD user 122 entering his or her account number, a payment process to pay the app fee is initiated and completed to activate the app. A promotional code box 1308 may also be included to activate the app for free or for a discount. Once the app is activated, the MRD user 122 is then able to listen to and enjoy the wireless audio service of the movie presentation through headsets, headphones or earbuds connected to their MRD 120. No password, proof-of-ticket-purchase, or other authentication process is required according to this embodiment of the invention. At most, all that is required is a fee to purchase and activate the app and selection of the appropriate theater number to tune the receiver of the mobile device 900/MRD user 120 to the appropriate frequency.

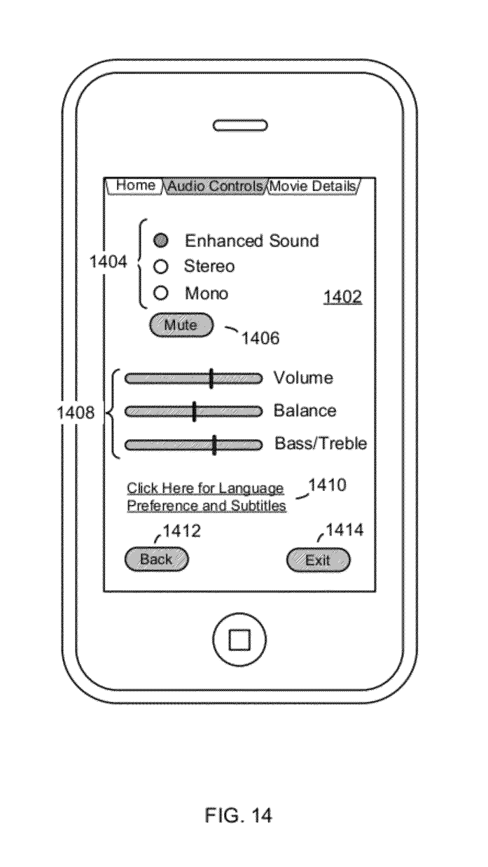

In response to the MRD user 122 selecting the “audio controls” tab on the GUI home page, the app causes the CPU 902 of the mobile device 900/MRD 120 to present an audio control GUI page 1402 to the display 806 of the mobile device 900/MRD 120, as illustrated in FIG. 14. The audio control GUI page 1402 includes various user controls, such as radio buttons 1404 which the MRD user 122 may select to listen to the movie soundtrack and dialogue in enhanced sound, stereo, or mono; a MUTE button 1406; volume, balance and tone (bass/treble) slider controls 1408, hyperlinks 1410 (or other tab) to language preference and/or subtitles; and BACK and EXIT buttons 1412 and 1414.

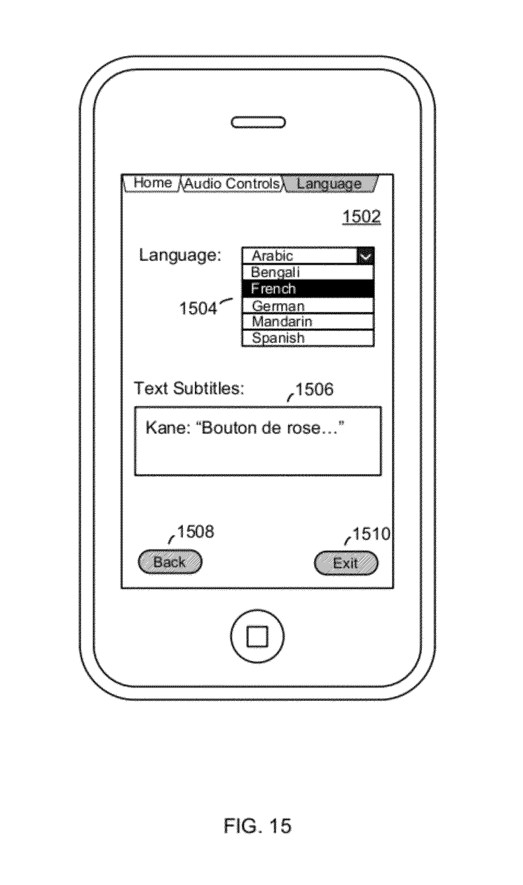

Upon clicking on the language preference and subtitles link 1410, the app causes the CPU 902 to display a language preference and subtitles GUI page 1502 on the display 906 of the mobile device 900/MRD 120, as illustrated in FIG. 15. The controls on the language preference and subtitles GUI page 1502 include a language setting drop down list 1504 for selecting the language of the audio presented to the MRD user 122; text subtitles box 1506 for presenting text subtitles in the MRD user's 122's preferred language; and BACK and EXIT buttons 1508 and 1510.

The different languages and/or text subtitles may be provided to the MRD 120 in various ways. For example, in embodiments of the invention in which the MRDs 120 and APDU 108 are configured to communicate in a wireless LAN, the APDU 108 includes a wireless router having a wireless transceiver 412 configured to receive the language/subtitle preferences requests from the MRDs 120 and direct the requested language/subtitle preferences to a media server configured in the network, for example the CPS 602 in FIG. 6. The media server responds to the language/subtitle preference requests by retrieving the appropriate language-specific encrypted and/or encoded digital audio and text subtitles media from the image and audio source 106, local A/V content store 606, or other language and subtitle source, and directing the retrieved encrypted and/or encoded digital audio and text subtitle media to the APDU transceiver 412, which upconverts and broadcasts the stream over the wireless LAN to the MRDs 120. In this manner the MRD user 122 is able to receive the wireless audio service and/or read text subtitles of the movie dialog in their preferred languages.

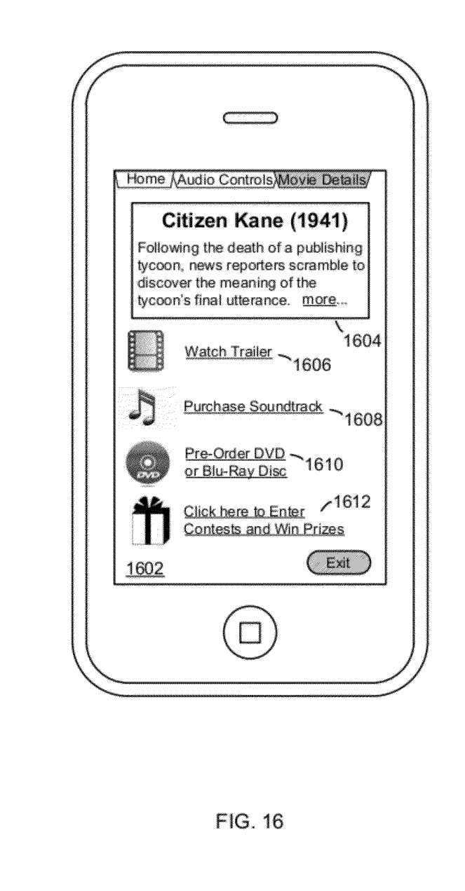

The app may be further configured to present information or details about the movie being presented. For example, in response to an MRD user's 122's selection of the “movie details” tab of the page tabs 1204, the app causes the CPU 902 to present a movie details page 1602 on the display 906 of the mobile device 900/MRD 120, as illustrated in FIG. 16. The movie details page 1602 includes a text window 1604 for displaying details of the movie being presented (e.g., synopsis, plot, director, release date, stars, reviews, etc.). The movie details are provided by the image and audio source 106, information stored in the local A/V content store 606, or from a remote source (for example a movie database server connected to the Internet) and served by the CPS 602 to the APDU 108. The app may also be configured to generate and display a hyperlink 1606 of the web address of a web server (e.g., the movie info server 1016 in FIGS. 10 and 11), from which MRD users 122 can download movie information (e.g., movie trailers and further details of the movie being presented), and/or hyperlinks 1608 and 1610 of web addresses of one or more vendor web servers (e.g., the merchandise web server 1018 in FIGS. 10 and 11) from which MRD users 122 may purchase the movie soundtrack, pre-order a digital video disk (DVD) or Blu-Ray Disc of the movie being presented, order tickets to future movie presentations, and/or purchase or rent other movie-related or non-movie-related merchandise. Finally, the app may also be configured to generate and display one or more hyperlinks 1612 to one or more marketing and/or promotional web servers (e.g., the marketing or promotional web server 1020 in FIGS. 10 and 11), from which MRD users may access and/or participate in promotional and/or marketing-related processes or events (e.g., entering contests, completing surveys, etc.).

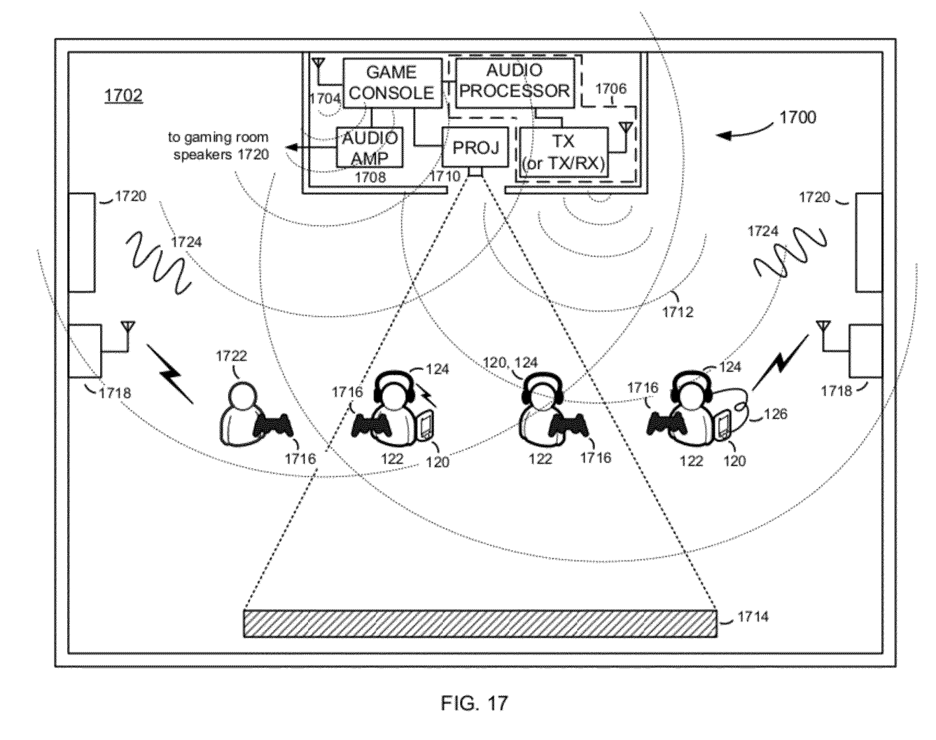

As explained at the beginning of this detailed description of the invention, the methods, systems and apparatus of the present invention may be employed in other audiovisual presentation venues other than movie theaters, and for other types of audiovisual presentations and events other than movie presentations. FIG. 17 illustrates, for example, how the methods, systems and apparatus of the present invention are configured in a gaming system 1700 for public electronic gaming competitions. The gaming system 1700 is deployed in an audiovisual presentation room or space (referred to as a “gaming room 1702” below), and comprises a game console 1704, APDU 1706, audio amp 1708, and digital video projector 1710. It should be noted that whereas only a single gaming system 1700 is shown, multiple gaming systems 1700 for multiple games may be deployed in multiple gaming rooms, using a network approach similar to that described above in reference to FIG. 8.

The APDU 1706 of the gaming system 1700 is configured to receive digital audio signals from the game console 1704; generate encrypted and/or encoded audio signals of the game audio; and broadcast a wireless carrier 1712 modulated by the encrypted and/or encoded audio signal to the MRDs 120 of the MRD users 122/gamers, using techniques similar to those described above. Meanwhile, the digital video projector 1710 projects images of the game being played onto a projection screen 1714 using video signals from the game console 1704. (Other display means besides a digital image projector may be alternatively used, such as a LCD, LED display, organic LED panel, or plasma technology display.)

In addition to being equipped with MRDs 120, the MRD users 122/gamers are also equipped with wireless game controllers 1716 that have wireless transceivers for transmitting user control input signals and receiving control and haptic feedback signals for the game controllers 1716 from a wireless transceiver in, attached to, or in communications with the game console 1704.

Authorized MRDs 120 carried or worn by the MRD users 122/gamers receive and demodulate the modulated wireless carrier 1712, and decrypt and decode the encrypted and/or encoded audio signal, similar to described above, allowing the MRD users 122/gamers to listen to the game music and dialogue (if any) through their headsets, headphones or earbuds 124 while playing or competing in game play. To improve the distribution of the modulated wireless carrier 1712 to faraway, recessed or shielded areas of the gaming room 1702, wireless repeaters, base stations, or APs 1718 may be installed throughout the gaming room 1702.

The MRDs 120 may also be equipped with an app, similar to the movie app described above, which MRD users 122 may download and interact with to, among other things: activate and control features of the wireless audio service from the APDU 1706 (e.g., enhanced sound, stereo, mute, balance, treble/bass, etc.); set language settings; access details (e.g., cheats, walkthroughs, game-playing instructions) of the game being played; and purchase game-related merchandise.

The audio amplifier 1708, which is built in or attached to the game console 1704, amplifies the game audio and directs the amplified game audio to gaming room speakers 1720. This allows spectators and gamers who are not authorized or equipped to access the wireless audio service, like gamer 1722, to listen to the game music and dialogue from sound waves 1724 produced by the gaming room speakers 1720.

While various embodiments of the present invention have been described above, it should be understood that they have been presented by way of example, and not limitation. It will be apparent to persons skilled in the relevant art that various changes in form and detail may be made therein without departing from the spirit and scope of the invention. The scope of the invention should, therefore, be determined not with reference to the above description, but should instead be determined with reference to the appended claims, along with the full scope of equivalents to which such claims are entitled.

What is claimed is:

1. A method of generating and providing a wireless audio service for an audiovisual presentation, comprising:
processing audio from an audio source of an audiovisual presentation; and
broadcasting the processed audio as a wireless audio service throughout an audiovisual presentation room or space for reception by a plurality of mobile receiving devices (MRDs) having or comprising headsets, headphones or earbuds through which MRD users listen to audio of the audiovisual presentation provided by the wireless audio service while viewing images of the audiovisual presentation.

2. The method of claim 1, wherein processing audio from the audio source of the audiovisual presentation comprises processing soundtrack and dialogue audio from a movie audio source, and broadcasting the processed audio comprises broadcasting the processed soundtrack and dialogue audio as the wireless audio service.

3. The method of claim 1, wherein processing audio from the audio source comprises encoding the audio according to a psychoacoustic encoding algorithm or other sound-enhancing process.

4. The method of claim 1, further comprising controlling which MRDs of the plurality of MRDs may access the wireless audio service.

5. The method of claim 4, wherein access to the wireless audio service by an MRD is controlled based on whether a software application for controlling features of the wireless audio service is installed on the MRD.

6. The method of claim 1, wherein processing audio comprises processing audio from an audio source that provides audio of the audiovisual presentation in multiple languages, and broadcasting the processed audio comprises broadcasting the processed audio in multiple languages.

7. The method of claim 1, further comprising:
receiving a language preference request from an MRD;
processing audio from an audio source containing audio in a language of the requested language preference; and
transmitting the wireless audio service in the requested language preference to the requesting MRD.

8. A method performed by a mobile device, comprising:
receiving by a receiver in the mobile device, encrypted and/or encoded audio of an audiovisual presentation from a wireless transmitter of an audiovisual presentation system configured to broadcast the encrypted and/or encoded audio as a wireless audio service throughout an audiovisual presentation room or space;
decrypting and/or decoding the received encrypted and/or encoded audio to produce decrypted and/or decoded audio;
using the decrypted and/or decoded audio to generate audio signals for driving headsets, headphones or earbuds that connect to the mobile device and through which the audio of the audiovisual presentation provided by the wireless audio service may be listened to by a user of the mobile device; and
presenting a graphical user interface (GUI) to the user of the mobile device, said GUI including user controls for controlling audio characteristics of audio provided by the wireless audio service.

9. The method of claim 8, wherein the audiovisual presentation room or space is a movie theater, and the encrypted and/or encoded audio comprises encrypted and/or encoded soundtrack and dialogue audio of a movie presentation being presented in the movie theater.

10. The method of claim 8, wherein decrypting and/or decoding the received encrypted and/or encoded audio comprises decoding audio that has been encoded according to an encoding algorithm configured to produce multi-dimensional or multi-channel enhanced sound effects in the mobile device headsets, headphones or earbuds.

11. The method of claim 8, wherein presenting said GUI includes presenting GUI controls that provide the mobile device user the ability to set and control characteristics of the wireless audio service.

12. The method of claim 11, wherein presenting the GUI controls comprises presenting a GUI selector which the mobile device user can manipulate to select a sound option for listening to audio provided by the wireless audio service in enhanced sound.

13. The method of claim 8, wherein presenting said GUI includes presenting a preferred language control that the mobile device user can manipulate to specify and request a language in which the audiovisual presentation system generates and provides the wireless audio service.

14. The method of claim 8, wherein presenting said GUI includes presenting a hyperlink to a website that provides information about the audiovisual presentation.

15. The method of claim 8, wherein presenting said GUI includes presenting one or more hyperlinks to one or more websites from which the user of the mobile device may rent or purchase merchandise relating to the audiovisual presentation.

16. The method of claim 8, wherein presenting said GUI includes presenting one or more hyperlinks to one or more promotional or marketing websites.

17. The method of claim 8, wherein presenting said GUI includes presenting a password entry box into which the mobile device user enters a password for submission to an authenticating authority, in order to gain access to the wireless audio service.

18. The method of claim 8, wherein access to the wireless audio service is controlled based on whether a software application has been purchased or downloaded and installed on the mobile device.

19. A mobile system, comprising:
a processor;
a computer-readable medium coupled to the processor and having instructions stored thereon, which, when executed by the processor, causes the processor to perform operations including:
processing audio signals received from an audio processing and distribution apparatus providing a wireless audio service for an audiovisual presentation; and
presenting a graphical user interface (GUI) on a mobile device, said GUI including user controls for controlling audio characteristics of the audio provided by the wireless audio service.

20. The mobile system of claim 19, wherein the audiovisual presentation is a movie being presented in a theater, and processing audio signals received from the audio processing and distribution apparatus comprises processing soundtrack and dialogue audio of the movie.

21. The mobile system of claim 19, wherein processing audio signals comprises decoding audio signals received from the audio processing and distribution apparatus comprises decoding audio signals that have been encoded according to a psychoacoustic encoding algorithm or other sound-enhancing process.

22. The mobile system of claim 19, wherein said instructions include instructions, which, when executed by the processor, causes the processor to activate or enable a codec used to decrypt and/or decode the audio signals received from the audio processing and distribution apparatus.

23. The mobile system of claim 19, wherein said instructions include instructions, which, when executed by the processor, causes the processor to download or store a codec used to decrypt and/or decode the audio signals received from the audio processing and distribution apparatus.

24. The mobile system of claim 19, wherein said instructions include instructions, which, when executed by the processor, causes the processor to respond to GUI user controls for setting and adjusting sound characteristics of the audio provided by the wireless audio service.

25. The mobile system of claim 19, wherein said instructions include instructions, which, when executed by the processor, causes the processor to respond to a language preference setting provided by a user of the mobile device through the GUI.

26. The mobile system of claim 19, wherein said instructions include instructions, which, when executed by the processor, causes the processor to respond to an audiovisual presentation information request made by a user of the mobile device through the GUI, by requesting information about the audiovisual presentation from a remote audiovisual presentation information server and directing audiovisual presentation information received from the remote server to a display of the mobile device.

27. The mobile system of claim 19, wherein said instructions include instructions, which, when executed by the processor, causes the processor to respond to activation of a GUI hyperlink by a user of the mobile device interacting with the GUI, said GUI hyperlink associated with a website address of a website from which a user of the mobile device may rent or purchase merchandise relating to the audiovisual presentation.

28. The mobile system of claim 19, wherein said instructions include instructions, which, when executed by the processor, causes the processor to respond to activation of a GUI hyperlink by a user of the mobile device interacting with the GUI, said GUI hyperlink associated with a website address of a website which the user of the mobile device may access or participate in promotional or marketing-related processes or events.

29. The mobile system of claim 19, wherein said instructions include instructions, which, when executed by the processor, causes the processor to tune a receiver of the mobile device to a frequency at which the audio processing and distribution apparatus broadcasts the wireless audio service.

30. The mobile system of claim 19, wherein the mobile system comprises a headset, headphones or earbuds within which said processor and said computer-readable medium are contained.
